(19) United States
(12) Patent Application Publication
(10) Pub. No.: US 2019/0284852 A1
(43) Pub. Date: Sep. 19, 2019

(54) Security Door Hinge Assist System

(71) Applicant: David Taylor, Nalcrest, FL (US)

(72) Inventor: David Taylor, Nalcrest, FL (US)

(21) Appl. No.: 16/434,765

(22) Filed: Jun. 7, 2019

Related U.S. Application Data
(60) Provisional application No. 62/682,457, filed on Jun. 8, 2018.

(51) Int. Cl. E05C 17/00; E05F 5/06

(52) U.S. Cl. CPC E05C 17/025; E05Y 2900/132; E05Y 2201/224; E05F 5/06

(57) ABSTRACT

A security door hinge assist system. The system includes a pair of stop plate members each including a planar member with angular extensions. Each stop plate member includes a plurality of threaded fastener apertures thereon. The pair of stop plate members are adapted such that one stop plate is affixed to a door and the other stop plate is affixed to the door frame. If an attempt to open the door outwardly is made when the door's hinge pins are removed, the stop plate members contact each other and prevent the door from opening outwardly. While the hinge pins are installed, the stop plate members do not contact each other and allow the door to freely swing open and closed. The system can be utilized to prevent unwanted access to a building that has a door with outside hinges by preventing the door from being pulled outwardly from the frame.

### CROSS REFERENCE TO RELATED APPLICATIONS

This application claims the benefit of U.S. Provisional Application No. 62/682,457 filed on Jun. 8, 2018. The above identified patent application is herein incorporated by reference in its entirety to provide continuity of disclosure

### BACKGROUND OF THE INVENTION

The present invention relates to door hinges. More specifically, the present invention relates to a security door hinge assist system for doors with hinges located on the outside of the building, such that said doors cannot be opened outwardly when the hinge pins are removed.

Some exterior doors include exterior hinges that allow the door to rotate outwardly from the building toward the outside. This arrangement provides an easy egress in the event of a fire or other emergency, so many exterior doors include this type of hinge arrangement. However, one drawback to doors having exterior hinges is that they are sometimes vulnerable to being broken into via loosened and removed hinge pins. If an intruder is able to remove the hinge pins, which can be accessed due to their position on the exterior of the building, the intruder may be able to bypass a locked door by pulling the now hingeless door outwardly off of the door frame, thereby jeopardizing the safety of residents in the household in which the intruder is breaking and entering. Some individuals may address such a risk associated with exterior hinges by installing interior hinges, such that a door may open inward. However, inward opening doors are often less safe in that they cannot be quickly pushed outward. Further, when a door opens inwardly, it takes up a large amount of space within the interior of the structure to which the door provides access. This can be inconvenient for small interior areas and areas that have a lot of foot traffic.

Devices have been developed to prevent the unwanted opening of a door. However, these devices have several drawbacks. Some individuals utilize door bars that are wedge against a door to prevent inward movement. While these can be effective, they are often difficult to deploy and must be removed before the door can be used normally, which can be time consuming and inconvenient. Other door stop devices are often bulky and unsightly when installed. Accordingly, the present invention provides a security door hinge assist system configured to secure an exteriorly-hinged outwardly opening door even if the door hinges are removed, thereby providing safety to the individuals and items within the structure protected by the door.

In light of the devices disclosed in the known art, it is submitted that the present invention substantially diverges in design elements from the known art and consequently it is clear that there is a need in the art for an improvement to existing security door hinge assist systems. In this regard, the instant invention substantially fulfills these needs.

### SUMMARY OF THE INVENTION

In view of the foregoing disadvantages inherent in the known types of security door hinges now present in the known art, the present invention provides a security door hinge assist system wherein the same can be utilized for providing convenience by preventing a door with outside hinges from being pulled outwardly and removed when the hinge pins are removed. The present system comprises a first stop plate and a second stop plate each having a planar attachment portion and an angled flange portion, wherein a plurality of fastener apertures are disposed on the attachment portions. The stop plate members are adapted to affix to the body of a door and the door jamb, respectively, in a manner such as to prevent the door from being opened outwardly in the event that its exterior hinges have been removed.

It is therefore an object of the present invention to provide a new and improved security door hinge that has all of the advantages of devices in the known art and none of the disadvantages.

It is another object of the present invention to provide a security door hinge assist system wherein the stop plate members comprise a rigid and inelastic construction such as metal.

Another object of the present invention is to provide a security door hinge assist system wherein the angled flanges of each of the stop plate members align flush with each other when the door is in a closed position.

Yet another object of the present invention is to provide a security door hinge assist system wherein the stop plate members are symmetrical and comprise a unitary elongated planar construction.

Another object of present invention is to provide a security door hinge assist system wherein the apertures disposed on the attachment portion of each stop plate member are adapted to receive standard metallic screw fasteners therethrough.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a side elevation view of a stop plate component of an embodiment of the security door hinge assist system.

FIG. 1B shows a top plan view of a stop plate component of an embodiment of the security door hinge assist system.

FIG. 2A shows a perspective view of a stop plate component of an embodiment of the security door hinge assist system.

FIG. 2B shows an alternate perspective view of a stop plate component of an embodiment of the security door hinge assist system.

FIG. 3 shows a perspective view of an embodiment of the security door hinge assist system with stop plate members installed on an open doorway.

FIG. 4 shows a perspective view of an embodiment of the security door hinge assist system with stop plate members installed on a closed doorway.

FIG. 5 shows a top-down view of an embodiment of the security door hinge assist system on an outwardly opening door system.

### DETAILED DESCRIPTION OF THE INVENTION

Reference is made herein to the attached drawings. Like reference numerals are used throughout the drawings to depict like or similar elements of the security door hinge assist system. For the purposes of presenting a brief and clear description of the present invention, the preferred embodiment will be discussed as used for protecting an outwardly opening door having hinges on the exterior of a building from being tampered with from the outside. The figures are intended for representative purposes only and should not be considered to be limiting in any respect.

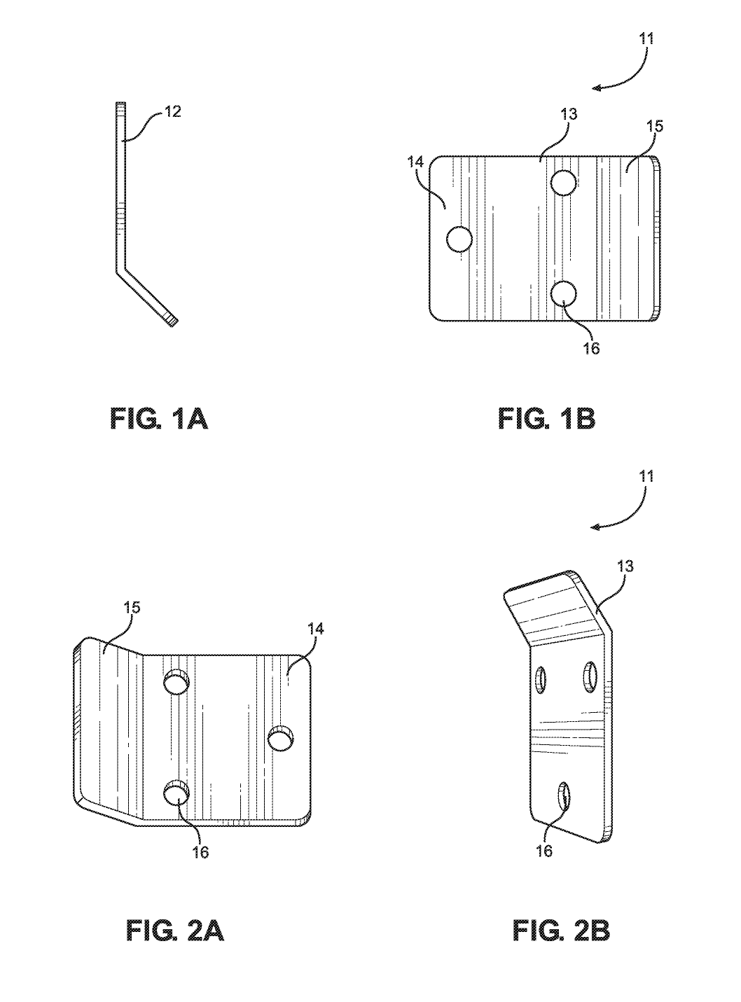

Referring now to FIGS. 1A, 1B, 2A, and 2B, there are shown multiple views of the stop plate components of an embodiment of the security door hinge assist system. The security door hinge assist system 11 comprises a pair of stop plate members 12 and 13 configured to be used in tandem with one another. In the illustrated embodiment, the stop plate members 12, 13 are symmetrical. Each stop plate member 12, 13 includes a planar attachment portion 14 and an angled flange portion 15. The attachment portion 14 includes a plurality of apertures 16 adapted to receive fasteners, such as standard metallic screw fasteners, therethrough. The stop plate members 12, 13 are each formed from a single, unitary piece. The stop plate members 12, 13 are composed of a material having rigid and inelastic properties such that they will not bend, break, or shear when put under significant stress loads. In the illustrative embodiment, the stop plate members 12, 13 include a metallic alloy construction, but may include any material having sufficient rigid and inelastic properties as desired by a user.

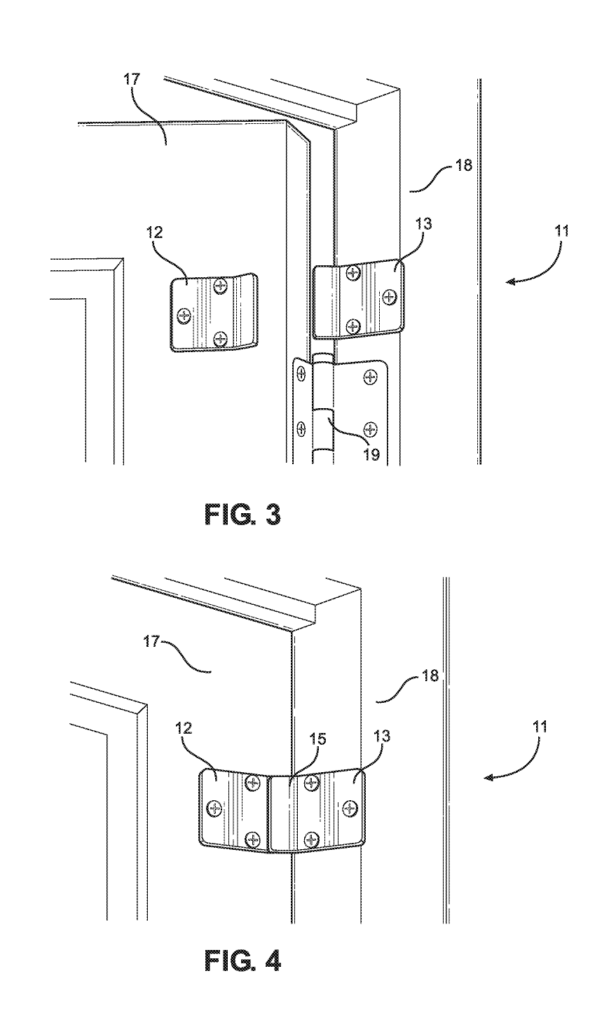

Referring now to FIGS. 3-5, there are shown multiple views of an embodiment of the security door hinge assist system with stop plate members installed on an open doorway. When installed, the first stop plate member 12 and the second stop plate member 13 are affixed to separate surfaces. The first stop plate member 12 is attached to the body of the door 17, while the second stop plate member 13 is attached to the door jamb 18. The component members of the security door hinge assist system 11 are installed on the door 17 surface and door jamb 18 on a side opposite that of which the hinge 19 is disposed, such that hinge 19 and stop plate members 12, 13 are situated on opposite sides of a closed door. The security door hinge assist system 11 is installed along the edge of the door which is hingedly attached to the frame. In the illustrated embodiment, two pairs of stop plate members 12 and 13 are installed along the edge of the door 17 surface and the door jamb 18 near the top and bottom of the entryway. In other embodiments, the system 11 may include only one pair of stop plate members, or may include any additional number stop plate members, for added protection and effectiveness.

Referring now to FIG. 4 specifically, there is shown a perspective view of an embodiment of the security door hinge assist system installed on a closed doorway. When installed, the first stop plate member 12 and the second stop plate member 13 are aligned such that their respective angled flanges 15 will rest flush against one another when the door 17 is in a closed position. The angled flange 15 of the first stop plate member 12 will overlap the angled flange 15 of the second stop plate member 13 in a manner that keeps the angled flange 15 of the second stop plate member 13 attached to the door jamb 18 on the inside when the door is in a closed position. In the illustrated embodiment, the angled flanges 15 are angled at approximately 45-degree angles from the surfaces they are affixed to and create a roughly 135-degree angle between the attachment portion 14 and the angled flange 15. In alternate embodiments, the angled flanges 15 may comprise a different angle. The angled flanges 15 may open with a door naturally so that the flange 15 of the first stop plate member 12 separates from that of the second stop plate member 13 when the door 17 is operated along its hinges 19. In this way, the security door hinge assist system 11 prevents outward opening of the door when the hinges are removed, but allows the door to open outwardly to the exterior as normal and without interference when the hinges are installed.

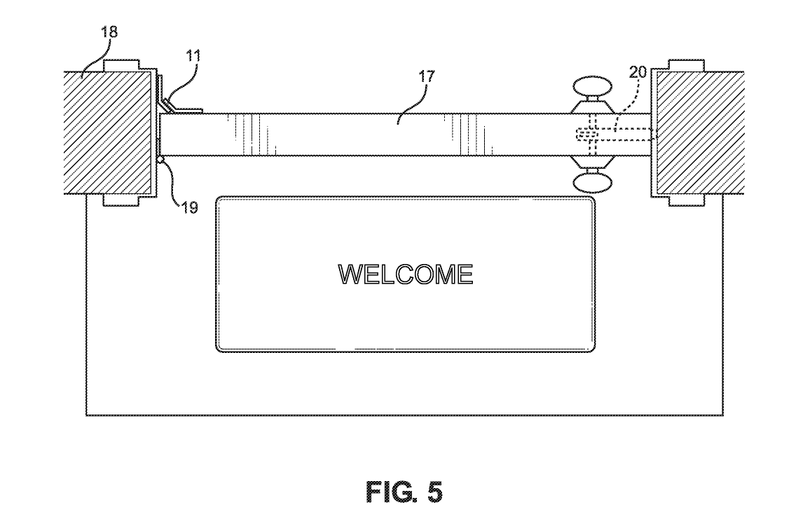

Referring now to FIG. 5 specifically, there is shown a top-down view of an embodiment of the security door hinge assist system on an outward opening door system. In practice, the security door hinge assist system 11 is used to ensure that a door 17 that has had its hinge pins removed or otherwise has been taken off its hinges 19 cannot be pulled outwardly away from the frame or otherwise removed from the doorway to defeat a locking mechanism 20. Entry doors which open outward and have external hinges 19 are at risk of being tampered with and dislodged by persons outside of the dwelling or structure. The pins from the hinges 19 can be taken out and thus allow for the door to be pulled out of the doorway to bypass locking mechanisms 20. The security door hinge assist system 11 prevents a door which has been taken off its hinges 19 from being removed outwardly from the doorway. When a door 17 has been removed from its hinges 19 and is attempted to be pulled out of the doorway in the direction of the hinges 19, the angled flange 15 of the first stop plate member 12 affixed to the door surface will come into contact with, and prevented from moving by, the angled flange 15 of the second stop plate member 13 affixed to the door jamb 18. In this way, doors 17 installed with the security door hinge assist system 11 may not be removed outward towards the hinges 19 while the locking mechanism 20 is in place. The greater the number of pairs of stop plate members that are utilized, the more force will be required to move the door and gain entry. In this way, the present invention can be scaled up to provide high levels of security and prevent any unwanted intrusion through an externally opening door.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A security door hinge assist system, comprising:
a first stop plate member and a second stop plate member, wherein each of the first stop plate member and the second stop plate member comprises a planar attachment portion and an angled flange portion extending from one edge thereof;
a plurality of apertures disposed on the attachment portion of each of the first stop plate member and second stop plate member, wherein each aperture of the plurality of apertures is adapted to receive a fastener therethrough;
wherein the first stop plate member and the second stop plate member are configured to prevent an exteriorly opening door with outside hinges from being pulled outwardly away from a door frame when the first stop plate member is attached to the exteriorly opening door and the second stop plate member is attached to a door jamb of the exteriorly opening door in such a way that the first stop plate member and the second stop plate member are aligned with each other in a common vertical plane.

2) The security door hinge assist system of claim 1, wherein the first and second stop plate members are constructed of one or more rigid and inelastic materials.

3) The security door hinge assist system of claim 2, wherein the first and second stop plate members include a metallic construction.

4) The security door hinge assist system of claim 1, wherein the first stop plate member and the second stop plate member are affixed to the body of the door and the door jamb on a side opposite a hinge of the door.

5) The security door hinge assist system of claim 1, wherein the angled flanges of the first and second stop plate members are configured to align flush when the door is in a closed position.

6) The security door hinge assist system of claim 1, wherein each aperture of the plurality of apertures is adapted to receive a standard metallic screw fastener therethrough.

7) The security door hinge assist system of claim 1, wherein the first stop plate member and the second stop plate member comprise a unitary construction.

8) The security door hinge assist system of claim 1, wherein the first stop plate member and the second stop plate member are symmetrical.

9) The security door hinge assist system of claim 1, wherein the attachment portion of the first stop plate member and the second stop plate members are planar.

10) A security door hinge assist system, comprising:
A first pair of first stop plate members comprising a first stop plate member and a second stop plate member, wherein each of the first stop plate member and the second stop plate member comprises a planar attachment portion and an angled flange portion extending from one edge thereof;
a second pair of stop plate members comprising a third stop plate member and a fourth stop plate member, wherein each of the third stop plate member and the fourth stop plate member comprises a planar attachment portion and an angled flange portion extending from one edge thereof;
wherein the first pair of stop plate members are aligned with an upper end of a door;
wherein the second pair of stop plate members are aligned with a lower end the door;
a plurality of apertures disposed on the attachment portion of each of the first stop plate member, second stop plate member, third stop plate member, and fourth stop plate member, wherein each aperture of the plurality of apertures is adapted to receive a fastener therethrough;
wherein the first pair of stop plate members and the second pair of stop plate members are configured to prevent outward movement of an exteriorly opening door that has had its hinges removed when the first and third stop plate members are attached to a body a door and the second and fourth stop plate members are attached to a door jamb of the door in such a way that the first stop plate member and the second stop plate member are aligned with each other in a first vertical plane, and the third stop plate member and the fourth stop plate member are aligned in a second vertical plane.

11) The security door hinge assist system of claim 10, wherein the first, second, third, and fourth stop plate members are constructed of one or more rigid and inelastic materials.

12) The security door hinge assist system of claim 11, wherein the first, second, third, and fourth stop plate members include a metallic construction.

13) The security door hinge assist system of claim 10, wherein the second stop plate member and the fourth stop plate member are affixed to the jamb of the door on a side opposite a hinge of the door.

14) The security door hinge assist system of claim 10, wherein the first stop plate member and the third stop plate member are affixed to the body of the door on a side opposite a hinge of the door.

15) The security door hinge assist system of claim 10, wherein the angled flanges of the first and second stop plate members are configured to align flush when the door is in a closed position, and wherein the angled flanges of the third and fourth stop plate members are configured to align flush when the door is in a closed position.

16) The security door hinge assist system of claim 10, wherein each aperture of the plurality of apertures is adapted to receive a standard metallic screw fastener therethrough.

17) The security door hinge assist system of claim 10, wherein the first, second, third, and fourth stop plate members each comprises a unitary construction.

18) The security door hinge assist system of claim 10, wherein the first, second, third, and fourth stop plate members are symmetrical.

19) The security door hinge assist system of claim 10, wherein the attachment portion of the first, second, third, and fourth stop plate members are planar.
